(19) United States
(12) Patent Application Publication
(10) Pub. No.: US 2021/0221066 A1
(43) Pub. Date: Jul. 22, 2021

(54) GAS CONDITIONING BY ADDITIONAL GAS MANAGEMENT AND MONITORING TOOL

(71) Applicant: Concept Laser GmbH, Lichtenfels (DE)

(72) Inventor: Tim Doehler, Grosheirath (DE)

(21) Appl. No.: 16/745,442

(22) Filed: Jan. 17, 2020

(51) Int. Cl. B29C 64/371; B29C 64/153; B33Y 40/00; B33Y 10/00; B33Y 30/00; B01D 53/26

(52) U.S. Cl. CPC B29C 64/371; B29C 64/153; B33Y 40/00; B01D 2221/14; B01D 53/26; B33Y 10/00; B01D 2257/104; B33Y 30/00; B01D 2257/80

(57) ABSTRACT

An apparatus for additively manufacturing three-dimensional objects may include a stream generating unit configured to generate a gas stream that flows through a process chamber of the apparatus, and a gas processing device that includes at least one gas determination unit configured to determine a composition of the gas stream. The gas processing device may be configured to guide the gas stream to at least one gas purification device and/or to the process chamber based at least in part the determined gas parameter.

### BRIEF DESCRIPTION

Aspects and advantages will be set forth in part in the following description, or may be obvious from the description, or may be learned through practicing the presently disclosed subject matter.

In one aspect, the present disclosure embraces apparatuses for additively manufacturing three-dimensional objects. An exemplary apparatus may include stream generating unit configured generate a gas stream that streams through a process chamber of the apparatus, and a gas processing device that has at least one gas determination unit configured determine a composition of the gas that streams through the process chamber of the apparatus. The gas processing device may be configured to guide the gas stream to at least one gas purification device or to the process chamber based at least in part on the determined composition of the gas.

In another aspect, the present disclosure embraces methods of additively manufacturing three-dimensional objects. An exemplary method may include generating a gas stream with a stream generating unit and streaming the gas stream through a process chamber of an apparatus for additively manufacturing three-dimensional objects, and determining, with a gas processing device that includes at least one gas determination unit, a composition of the gas streaming through the process chamber of the apparatus, and guiding the gas stream, at least in part using the gas processing device, to at least one gas purification device or to the process chamber based at least in part on the determined composition of the gas.

These and other features, aspects and advantages will become better understood with reference to the following description and appended claims. The accompanying drawings, which are incorporated in and constitute a part of this specification, illustrate exemplary embodiments and, together with the description, serve to explain certain principles of the presently disclosed subject matter.

### BRIEF DESCRIPTION OF THE DRAWINGS

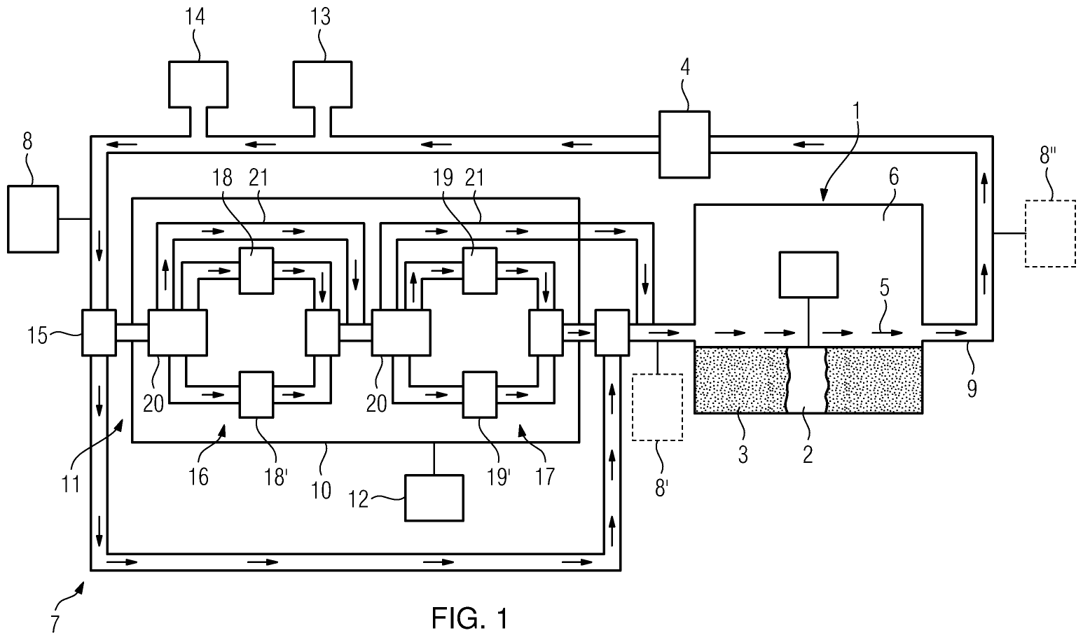

A full and enabling disclosure, including the best mode thereof, directed to one of ordinary skill in the art, is set forth in the specification, which makes reference to the appended FIG. 1, which shows an apparatus 1 for additively manufacturing three-dimensional objects.

Repeat use of reference characters in the present specification and drawings is intended to represent the same or analogous features or elements of the present disclosure.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components. The terms “a” and “an” do not denote a limitation of quantity, but rather denote the presence of at least one of the referenced item.

Here and throughout the specification and claims, range limitations are combined and interchanged, and such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems.

Exemplary embodiments of the present disclosure will now be described in further detail.

The present disclosure relates to an apparatus for additively manufacturing three-dimensional objects by way of successive layerwise selective irradiation and consolidation of layers of a build material which can be consolidated by way of an energy source. The apparatus may include a stream generating unit that may be configured to generate a gas stream streaming through a process chamber of the apparatus.

Apparatuses for additively manufacturing three-dimensional objects are generally known from prior art. Typically, an (inert) process atmosphere is generated inside a process chamber, i.e. the chamber in which the additive manufacturing process is performed to ensure that defined process requirements regarding the atmosphere and the contact of the build material with the atmosphere are met. Thus, it is known it to keep the gas inside the process chamber as pure as possible, for example argon can be used as (process) gas. The concentration of other gases or particles in the gas stream is reduced as far as possible. Hence, usually argon concentrations of above 99% are used as gas in the additive manufacturing process. To keep the level of gas above the predefined threshold value, e.g. above 99%, fresh gas is flooded into the process chamber to rinse the process chamber from other gases, particles or fluids, or replace other gases, particles or fluids, such as residues generated in the additive manufacturing process, oxygen or moisture.

Hence, it is only known to maximize the concentration of a component or minimize undesired components, e.g. maximize a ratio of “process gas” in the gas stream streaming through the process chamber, for example maximizing the concentration of argon and minimizing other components of the gas stream, for example residues, other gases or fluids.

It is an object of the present disclosure to provide an improved apparatus for additively manufacturing three-dimensional objects, including a more advanced control of the gas stream is possible in an additive manufacturing process performed on the apparatus.

The apparatus described herein is an apparatus for additively manufacturing three-dimensional objects, e.g. technical components, by way of successive selective layerwise consolidation of layers of a powdered build material (“build material”) which can be consolidated by way of an energy source such as an energy beam (e.g., a laser beam). A respective build material can be a metal, ceramic or polymer powder. A respective energy beam can be a laser beam. A respective apparatus can be an apparatus in which an application of build material and a consolidation of build material is performed separately, such as a selective laser sintering apparatus or a selective laser melting apparatus, for instance. Alternatively, the successive layerwise selective consolidation of build material may be performed via at least one binding material. The binding material may be applied with a corresponding application unit and, for example, irradiated with a suitable energy source, e.g. a UV light source.

The apparatus may comprise a number of functional units which are used during its operation. Exemplary functional units are a process chamber, an irradiation device may be configured to selectively irradiate a build material layer disposed in the process chamber with at least one energy beam, and a stream generating unit may be configured to generate a gaseous fluid stream at least partly streaming through the process chamber with given streaming properties, e.g. a given streaming profile, streaming velocity, etc. The gaseous fluid stream is capable of being charged with non-consolidated particulate build material, such as smoke or smoke residues generated during operation of the apparatus, while streaming through the process chamber. The gaseous fluid stream is typically inert, i.e. typically a stream of an inert gas, e.g. argon, nitrogen, carbon dioxide, etc.

In accordance with the present disclosure, an exemplary apparatus may include a gas processing device with at least one gas determination unit that may be configured to determine at least one gas parameter of the gas, such as a composition of the gas (e.g., a concentration of at least one component of the gas). The gas processing device may be configured to guide the gas stream to at least one gas purification device or to the process chamber based on the determined gas parameter. Thus, a gas processing device is provided with one or more determination units configured to determine a gas parameter of the gas of the gas stream that is streamed through the process chamber. For example, the determination unit may be configured to determine a composition of the gas stream, e.g. concentrations of different components of the gas stream, for example the concentration of an inert gas (process gas) used in the additive manufacturing process, such as argon, and concentrations of other components of the gas, such as oxygen, moisture (water) or residues.

Based on the determined gas parameter of the gas, the gas processing device guides the gas stream to at least one gas purification device or to the process chamber. Hence, it is possible to determine whether the gas can be reused, e.g. is suitable for being used in the additive manufacturing process, or whether a purification, i.e. a processing, of the gas is deemed necessary. For example, if the composition of the gas already meets predefined requirements, it is possible to directly reuse the gas and stream the gas back into the process chamber. If the gas parameter, e.g. the concentration of at least one component of the gas, does not meet predefined requirements, it is possible to guide the gas to the gas purification device to adjust the gas parameter accordingly.

Therefore, a certain composition of the gas streamed through the process chamber may be established, such as a composition that differs from a maximum or a minimum of a specific component (e.g. a maximum concentration of process gas), such as argon. Based on the specific gas parameter, such as a specific gas composition, the gas can be guided to the purification device may be configured to adjust the gas parameter. In some embodiments, the gas processing device may be configured to guide the gas stream to the process chamber based on a defined composition of the gas. Thus, if the gas composition of the gas that is removed from the process chamber, e.g. following a gas cycle or a gas transportation path, already matches a predefined or a desired composition, it is possible to directly reuse the gas and guide the gas back to the process chamber.

Advantageously, the consumption/wastage of fresh (process) gas, such as argon, can significantly be reduced, as the gas composition can be adjusted via the gas purification device and therefore, it is not necessary to replace the gas that has been removed from the process chamber with fresh gas but it is possible to purify, e.g. clean the gas, such as remove undesired components, before it is guided back to the process chamber. It is even possible to determine whether a purification or an adjustment to the gas parameter is necessary and, if the gas parameter already matches a predefined or a desired gas parameter, the gas stream can directly be guided back to the process chamber without a purification process. Hence, an additive manufacturing process performed on the apparatus can be performed more efficiently. For example, the use of gas can significantly be improved.

In accordance with the present disclosure, an apparatus may include a gas processing device configured to adjust a defined composition of the gas that is guided to the process chamber based on at least one build material parameter or process parameter. Hence, the defined composition of the gas can be adjusted by adjusting the gas parameter, such as changing the current composition of the gas. For example, the defined composition of the gas can be adjusted by removing (undesired) components from the gas. The term “removing” components does not necessarily involve a complete removal of that component but it is also possible to merely reduce that component of the gas to a defined level or concentration. Hence, it is possible to, inter alia, adjust the level/concentration of oxygen in the gas by reducing or increasing the concentration of oxygen in the gas.

The adjustment of the defined composition of the gas can be performed based on the build material parameter or a process parameter. Different properties of the build material used in the additive manufacturing process can be taken into calculation, for example the behavior, such as the consolidation behavior, of the build material. Since different build materials react differently in the additive manufacturing process based on the gas atmosphere surrounding the build material, different properties can be realized under different gas atmospheres present during additive manufacturing processes. For example, the concentration of oxygen in the gas stream directly influences mechanical properties of certain build materials, such as titanium. Therefore, it is possible to adjust/“tailor” properties, such as mechanical properties of the object that is additively manufactured during the additive manufacturing process by adjusting the defined composition of the gas based on the build material parameter.

Besides, it is also possible to adjust the defined composition of the gas based on a process parameter of the additive manufacturing process. For example, different parameters of the additive manufacturing process, such as the irradiation parameters, for example an intensity of the energy beam, a spot size of the energy beam, a scanning speed with which the energy beam is guided across a build plane, i.e. the plane in which build material is arranged to be irradiated, and the like can be taken into calculation. For example, it is possible to take the temperature of a consolidated zone or an irradiated zone of the build material into calculation and adjust the composition of the gas accordingly. Of course, it is possible to consider the build material parameter and the process parameter or various build material parameters of various process parameters and combine the adjustment of the defined composition of the gas based on at least one build material parameter and at least one process parameter, as well. The build material parameter may, inter alia, relate to a physical or chemical parameter of the build material used in the additive manufacturing process, such as a particle size and/or a particle size distribution and/or a type of build material used in the additive manufacturing process and the like.

Hence, in some embodiments, the gas processing device may be configured to adjust a defined composition based on the type of build material used in an additive manufacturing process performed on the apparatus and/or at least one object property, such as a mechanical property of the object. In other words, it is possible to adjust a defined composition of the gas based on which build material is used in the additive manufacturing process. As described before, different build materials comprise different properties, for example different consolidation behaviors and show different mechanical, physical or chemical properties based on the gas atmosphere under which they are processed. It is also possible to take at least one object property of the additively manufactured object into calculation. For example, it is possible to achieve a desired mechanical property of the object by accordingly influencing or adjusting the defined composition of the gas. For example, by changing the concentration of oxygen in the gas different mechanical properties of the object can be adjusted, such as tensile strength. Thus, a defined composition of the gas can be “tailored” based on the desired object properties, such as mechanical properties of the object.

In some embodiments, an apparatus may include a gas purification device that has at least one moisture removing unit configured to remove water from the gas stream and/or at least one gas removing unit configured to remove a gaseous component from the gas stream, such as an oxygen removing unit. In some embodiments, the gas purification device of the gas processing device may include at least one moisture removing unit and at least one gas removing unit. The moisture removing unit may be configured to remove moisture, i.e. water, from the gas stream, e.g. by drying the gas stream. The gas removing unit may be configured to remove gaseous components from the gas stream, e.g. configured to remove oxygen or other gases from the gas stream. In some embodiments, it is possible to use the gas removing unit to decrease the concentration of a specific gaseous component contained in the gas stream. Hence, the gas purification device may be configured to adjust different gas parameters of the gas, such as the concentration of different components (e.g. liquid components or fluid components, such as aerosols or gases).

In some embodiments, the moisture removing unit may include two moisture removing elements and/or the gas removing unit may include two gas removing elements, such as removing columns. Hence, each removing unit, i.e. the moisture removing unit and the gas removing unit, may comprise two corresponding removing elements, i.e. moisture removing elements or gas removing elements. Hence, it is possible to double the volumetric flow rate of gas that can be processed via the gas purification device or it is possible to use one of the removing elements as backup, for example while the other removing element is exchanged, renewed or refreshed, for instance. For example, a first gas removing element, e.g. an oxygen removing element, is used while the other corresponding gas removing element is being exchanged. Thus, a continuous process can be ensured, in which downtimes due to maintenance processes, such as changing, renewing or refreshing the removing elements, can be avoided.

Regarding the arrangement of the gas purification device, it is preferred that the moisture removing unit and the gas removing unit are arranged in series. The two moisture removing elements are arranged in parallel with respect to the streaming direction of the gas stream and/or the two gas removing elements are arranged in parallel with respect to a streaming direction of the gas stream. Hence, the moisture removing unit and the gas removing unit may be arranged in series each comprising at least two removing elements, i.e. moisture removing elements or gas removing elements, which two corresponding removing elements are arranged in parallel. Thus, it is possible to use one of the at least two different types of removing elements during operation of the gas processing device. The other removing element can be refreshed or renewed or exchanged without causing an interruption of the additive manufacturing process.

Therefore, in some embodiments, the gas purification device may be configured to guide the gas stream to one of the two moisture removing elements and/or one of the two gas removing elements based on an operational status, such as an operational status of one of the corresponding moisture removing elements or gas removing elements, respectively. As described before, it is advantageously possible that only one of the two removing elements provided with each removing unit is used during regular operation of the gas processing device. Hence, it is possible to have one removing element as backup, for example, if the operational status of the other removing element indicates that a refreshment or a renewal or an exchange of the removing element is necessary or currently performed.

The presently disclosed apparatus may include at least one moisture removing element and/or at least one gas removing element that has a refreshable or renewable removing material and/or removing structure, such as zirconium or a molecular sieve. Hence, in some embodiments, it is possible to refresh or renew the removing material used in the at least one moisture removing element and/or the at least one gas removing element. As removing material any suitable material may be used. For example, if oxygen has to be removed from the gas stream, zirconium can be used. Inter alia, it is possible to use a molecular sieve for removing moisture from the gas stream.

Further, the gas processing device may be configured to bypass the gas purification device, such as selectively bypass the at least one moisture removing unit and/or the at least one gas removing unit, based on the determined gas parameter, such as based on the defined composition (e.g., based on the at least one object property). Hence, based on the determined gas parameter the moisture removing unit and/or the gas removing unit can be bypassed, for example, if the moisture level or the concentration of a gaseous component already meets the defined composition. Of course, several gas removing units can be arranged in series, as well. The gas removing unit may be configured to remove a specific gaseous component from the gas stream. Hence, based on the determined gas parameter, e.g. based on the determined composition of the gas, it is possible to selectively bypass gas removing units and only guide the gas stream to gas removing units corresponding to the moisture or gaseous component that has to be reduced or removed.

Additionally, it is possible to bypass the gas purification device, such as the at least one moisture removing unit and/or the at least one gas removing unit based on the defined composition and/or based on the at least one object property. Hence, it is possible to consider desired object properties, such as mechanical properties of the object that has to be built during the additive manufacturing process. The defined composition may be adjusted based on the at least one object property. Based on the defined composition and an actual composition may be indicated via the determined gas parameter, it is possible to verify whether the gas meets the defined composition or whether a treatment/processing of the gas is necessary. Based on that information it is possible to guide the gas stream to the gas purification device or to bypass the gas purification device or at least one of its assigned units.

The gas processing device may further comprise a gas supply unit that may be configured to provide fresh gas and configured to adjust the volumetric flow rate of fresh gas provided to the gas cycle. Hence, via the gas supply unit it is possible to add fresh (process) gas to the gas cycle, i.e. the transportation structure through which the gas is streamed, e.g. a pipe structure. For example, via the gas supply it is possible to increase the concentration of process gas, such as argon in the gas that is streamed through the process.

In some embodiments, an exemplary apparatus may include a gas processing device that has a cover gas supply unit that may be configured to provide at least one cover gas and to adjust the volumetric flow rate of cover gas provided to the gas cycle. In the scope of this application the term “cover gas” refers to any arbitrary gas that can be provided to the gas cycle apart from the gas (process gas) that is used in the process, such as argon. The cover gas may include gasses in addition, or as an alternative, to usual cover gases. For example, the cover gas may contain any arbitrary gas, such as oxygen. Of course, the cover gas may also include or contain typical cover gases or shield gases pure or as one of at least two components. Further the term “cover gas supply unit” refers to any arbitrary number of supply units, for example integrated into one cover gas supply unit. Of course, it is also possible to have an individual cover gas supply unit for each gas that can be supplied to the gas cycle. Thus, it is possible to increase the concentration of different “cover gases”, such as oxygen and thereby, directly influence the gas composition used in the additive manufacturing process.

For example, if the determination process performed via the gas determination unit indicates that the concentration of a specific gaseous component is below a defined threshold value, it is possible to increase the volumetric flow rate of that gaseous component via the cover gas supply unit. For example, if a defined threshold value for (the concentration of) oxygen is 2% of the gas streaming through the process chamber and the determination process indicates that an actual concentration of oxygen is at 1%, the cover gas supply unit can be used to increase the concentration of oxygen to meet the defined threshold value. In this case, the corresponding gas removing unit (oxygen removing unit) can advantageously be bypassed to keep the desired oxygen concentration without removing oxygen from the gas cycle.

In some embodiments, an exemplary apparatus may include a gas processing device that has a valve arrangement configured to guide the gas stream to the process chamber or to the gas purification device. The valve arrangement may be configured to bypass the moisture removing unit and/or the gas removing unit, and the valve arrangement may be configured to guide the gas stream having been guided to the moisture removing unit selectively to one of the two moisture removing elements. Additionally, or in the alternative, the valve arrangement may be configured to guide the gas stream having been guided to the gas removing unit selectively to one of the two gas removing elements.

Hence, the valve arrangement allows for selectively guiding the gas stream through the gas processing device based on the gas parameter and based on a predefined gas parameter that has to be met. Based on whether the composition of the gas stream has to be adjusted, the gas processing device can use the valve arrangement to selectively guide the gas stream back to the process chamber or to the gas purification device. In the gas purification device it is possible to selectively bypass the moisture removing unit and/or the gas removing unit based on the gas parameter, such as based on whether moisture has to be removed from the gas stream and/or whether at least one gaseous component has to be removed from the gas stream. Hence, the gas stream can be guided through the gas processing device more efficiently, as the gas is only guided to purification or removing units, if needed. Also, it is possible to guide the gas stream based on the desired composition of the gas stream in that the gas stream is not guided to a gas removing unit in case the gas parameter indicates that the concentration of that specific component of the gas stream is already met or below the defined concentration.

In another aspect, the present disclosure relates to a gas processing device for an apparatus for additively manufacturing three-dimensional objects, such as the presently disclosed apparatus, as described herein, which gas processing device may be configured to receive a gas stream generated via a gas streaming device of the apparatus configured to generate the gas stream streaming through a process chamber of the apparatus. The gas processing device may include at least one gas determination unit that may be configured to determine at least one gas parameter of the gas, such as a composition of the gas (e.g., a concentration of at least one component of the gas). The gas processing device may be configured to guide the gas stream to at least one gas purification device or to a process chamber of the apparatus based on the determined gas parameter.

Further, the present disclosure relates to a method for operating an apparatus for additively manufacturing three-dimensional objects by way of successive layerwise selective irradiation and consolidation of layers of a build material which can be consolidated by way of an energy source. The apparatus may include a stream generating unit that may be configured to generate a gas stream streaming through a process chamber of the apparatus, in which at least one gas parameter of the gas is determined, such as a composition of the gas (e.g., a concentration of at least one component of the gas), and the gas stream is guided via a gas processing device to at least one gas purification device or to the process chamber based on the determined gas parameter.

Of course, all details, features and advantages described with respect to the presently disclosed apparatus are fully transferable to the presently disclosed gas processing device and the presently disclosed method.

An exemplary embodiment is described with reference to FIG. 1.

FIG. 1 shows an exemplary apparatus 1 for additively manufacturing three-dimensional objects 2 by way of successive layerwise irradiation and consolidation of layers of a build material 3. The apparatus 1 may include a stream generating unit 4, for example a pump configured to generate a gas stream 5 streaming through a process chamber 6, i.e. a chamber in which the additive manufacturing process is performed. The apparatus 1 may include a gas processing device 7 with the gas determination unit 8. The gas processing device 7 may comprise multiple gas determination units 8, as exemplarily indicated via reference signs 8′ and 8″. The gas determination unit 8 may be configured to determine at least one parameter of the gas of the gas stream 5 may be streamed through the process chamber 6 and through the pipe structure 9 of the gas processing device 7. Of course, the stream generating unit 4 may be considered part of the stream processing device 7. The arrangement of the stream generating unit 4 is arbitrary.

The gas parameter may, inter alia, relate to a composition of the gas, for example a concentration of different components of the gas, such as an argon concentration, an oxygen concentration or nitrogen concentration and the like. The gas processing device 7 may be configured to guide the gas stream 5 to at least one gas purification device 10 or to the process chamber 6 based on the determined gas parameter. To selectively guide the gas stream 5, the gas processing device 7 may include a valve arrangement 11 that has multiple valves, as will be described below.

Further, the apparatus 1 or the gas processing device 7 may include a control unit 12 may be configured to control the individual valves, the stream generating unit 4, a gas supply unit 13 and a cover gas supply unit 14, such as based on the determined gas parameter, which can be received by the control unit 12 from the gas determination unit 8. Based on the determined gas parameter, it is possible to increase the volumetric flow rate of fresh gas to the gas stream 5 via the gas supply unit 13 or a specific other gas, such as oxygen, for instance, via the cover gas supply unit 14. Hence, the control unit 12 may receive or generate a defined gas parameter threshold, i.e. a defined gas composition, which relates to a composition of the gas that is desired in the actual additive manufacturing process. The defined composition may be defined based on an object parameter of the object 2, for example build material dependent to achieve different mechanical properties, or other object properties, of the object 2 achieved during a consolidation process.

Further, it is possible to selectively guide the gas stream 5 into the gas purification device 10 based on the gas parameter determined via the determination unit 8. Therefore, the gas processing device 7 may include a first valve 15 via which the gas stream 5 can be guided selectively to the gas purification device 10 or to the process chamber 6. If the gas parameter indicates that at least one component of the gas stream 5 has to be adjusted, the gas stream 5 is guided via the valve 15 to the gas purification device 10. In this exemplary embodiment, the gas purification device 10 may include a moisture removing unit 16 and a gas removing unit 17, such as an oxygen removing unit.

The moisture removing unit 16 may include two moisture removing elements 18, 18′ and the gas removing unit 17 may include two gas removing elements 19, 19′. As can be derived from the Fig., the moisture removing unit 16 and the oxygen removing unit 17 arranged in series. The corresponding removing elements 18, 18′, 19, 19′ are arranged in parallel in each removing unit 16, 17. Hence, it is possible to use one removing element 18, 19 while the other removing element 18′, 19′ is being refreshed, renewed or exchanged or held as backup. The removing elements 18, 18′, 19 and 19′ are built as columns that includes corresponding material and/or corresponding structure that enables a removal of moisture and/or the at least one gaseous component from the gas stream 5.

To selectively guide the gas stream 5 to the moisture removing element 18 or the other moisture removing element 18′ the moisture removing unit 16 may include a valve 20. Further, it is possible to guide the gas stream 5 to a bypass 21 to bypass the moisture removing unit 16 based on the determined gas parameter. The gas removing unit 17 also may include a valve 20 may be configured to guide the gas stream 5 to the gas removing element 19 or the gas removing element 19′ or to bypass the gas removing unit 17 via the bypass 21. Hence, it is possible to bypass the moisture removing unit 16, if the gas parameter indicates that the moisture concentration in the gas stream 5 meets the defined composition. Analogously, the gas removing unit 17 can be bypassed via the bypass 21, if the determined gas parameter indicates that the respective concentration of the gaseous component meets (or is already below) the defined composition.

Therefore, it is possible to adjust a defined composition of the gas stream 5 that streams through the process chamber 6 for “tailoring” (mechanical) properties of at least one part of the object 2. For example, if titanium is used as build material 3 in the additive manufacturing process, a defined concentration of oxygen, e.g. 2%, can be adjusted. Hence, if the determined concentration of oxygen, as indicated via the determined gas parameter, is too low, oxygen can be provided to the gas cycle via the cover gas supply unit 14. Simultaneously, the gas stream 5 may be guided in that the gas removing unit 17, if used for removing oxygen from the gas stream 5, can be bypassed via the bypass 21. Otherwise, if the actual concentration of oxygen, as indicated via the gas parameter, is above the desired concentration of oxygen, the gas stream 5 can be guided to the gas removing unit 17 and the respective gaseous component, in this case oxygen, can be removed until the desired concentration is met.

The presently disclosed methods may be performed on the presently disclosed apparatus 1, such as using the presently disclosed gas processing device 7.

Further aspects of the present disclosure are provided by the subject matter of the following clauses:

1. An apparatus (1) for additively manufacturing three-dimensional objects (2) by means of successive layerwise irradiation and consolidation of layers of a build material (3) which can be consolidated by means of an energy source, which apparatus (1) comprises a stream generating unit (4) that is adapted to generate a gas stream (5) streaming through a process chamber (6) of the apparatus (1), characterized by a gas processing device (7) comprising at least one gas determination unit (8, 8′, 8″) that is adapted to determine at least one gas parameter of the gas, preferably a composition of the gas, in particular a concentration of at least one component of the gas, wherein the gas processing device (7) is adapted to guide the gas stream (5) to at least one gas purification device (10) or to the process chamber (6) dependent on the determined gas parameter.

2. An apparatus according to any preceding clause, characterized in that the gas processing device (7) is adapted to guide the gas stream (5) to the process chamber (6) dependent on a defined composition of the gas.

3. An apparatus according to any preceding clause, characterized in that the gas processing device (7) is adapted to adjust the defined composition of the gas that is guided to the process chamber (6) dependent on at least one build material parameter or process parameter.

4. An apparatus according to any preceding clause, characterized in that the gas processing device (7) is adapted to adjust the defined composition dependent on the type of build material (3) used in an additive manufacturing process performed on the apparatus (1) and/or at least one object property, preferably a mechanical property of the object (2).

5. An apparatus according to any preceding clause, characterized in that the gas purification device (10) comprises at least one moisture removing unit (16) adapted to remove water from the gas stream (5) and/or at least one gas removing unit (17), adapted to remove a gaseous component from the gas stream (5), preferably an oxygen removing unit.

6. An apparatus according to any preceding clause, characterized in that the moisture removing unit (16) comprises two moisture removing elements (18, 18′) and/or the gas removing unit (17) comprises two gas removing elements (19, 19′), in particular removing columns.

7. An apparatus according to any preceding clause, characterized in that the moisture removing unit (16) and the gas removing unit (17) are arranged in series, wherein the two moisture removing elements (18, 18′) are arranged in parallel with respect to a streaming direction of the gas stream (5) and/or the two gas removing elements (19, 19′) are arranged in parallel with respect to a streaming direction of the gas stream (5).

8. An apparatus according to any preceding clause, characterized in that the gas purification device (10) is adapted to guide the gas stream (5) to one of the two moisture removing elements (18, 18′) and/or one of the two gas removing elements (19, 19′) dependent on an operational status.

9. An apparatus according to any preceding clause, characterized in that the at least one moisture removing element (18, 18′) and/or the at least one gas removing element (19, 19′) comprise refreshable or renewable removing material and/or a removing structure, preferably zirconium or a molecular sieve.

10. An apparatus according to any preceding clause, characterized in that the gas processing device (7) is adapted to bypass the gas purification device (10), in particular the at least one moisture removing unit (16) and/or the at least one gas removing unit (17), dependent on the determined gas parameter, preferably dependent on the defined composition, in particular dependent on the at least one object property.

11. An apparatus according to any preceding clause, characterized in that the gas processing device (7) comprises a gas supply unit (13) that is adapted to provide fresh gas and adapted to adjust the volumetric flow rate of fresh gas provided to the gas cycle.

12. An apparatus according to any preceding clause, characterized in that the gas processing device (7) comprises a cover gas supply unit (14) adapted to provide at least one cover gas and adapted to adjust the volumetric flow rate of cover gas provided to the gas cycle.

13. An apparatus according to any preceding clause, characterized in that the gas processing device (7) comprises a valve arrangement (11) adapted to guide the gas stream (5) to the process chamber (6) or the gas purification device (10), wherein the valve arrangement (11) is adapted to bypass the moisture removing unit (16) and/or the gas removing unit (17), wherein the valve arrangement (11) is adapted to guide the gas stream (5) guided to the moisture removing unit (16) selectively to one of the two moisture removing elements (18, 18′) and/or wherein valve arrangement (11) is adapted to guide the gas stream (5) guided to the gas removing unit (17) selectively to one of the two gas removing elements (19, 19′).

14. A gas processing device (7) for an apparatus (1), for additively manufacturing three-dimensional objects (2), in particular for an apparatus (1) according to any preceding clause, which gas processing device (7) is adapted to receive a gas stream (5) generated via a gas streaming device (5) of the apparatus (1) adapted to generate the gas stream (5) streaming through a process chamber (6) of the apparatus (1), characterized in that the gas processing device (7) comprises at least one gas determination unit (8, 8′, 8″) that is adapted to determine at least one gas parameter of the gas, preferably a composition of the gas, in particular a concentration of at least one component of the gas, wherein the gas processing device (7) is adapted to guide the gas stream (5) to at least one gas purification device (10) or to a process chamber (6) of the apparatus (1) dependent on the determined gas parameter.

15. A method for operating an apparatus (1) for additively manufacturing three-dimensional objects (2) by means of successive layerwise selective irradiation and consolidation of layers of a build material (3) which can be consolidated by means of an energy source, in particular an apparatus (1) according to any preceding clause, which apparatus (1) comprises a stream generating unit (4) that is adapted to generate a gas stream (5) streaming through a process chamber (6) of the apparatus (1), characterized by determining at least one gas parameter of the gas, preferably a composition of the gas, in particular a concentration of at least one component of the gas, and guiding the gas stream (5) via a gas processing device (7) to at least one gas purification device (10) or to the process chamber (6) dependent on the determined gas parameter.

This written description uses exemplary embodiments to describe the presently disclosed subject matter, including the best mode, and also to enable any person skilled in the art to practice such subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An apparatus for additively manufacturing three-dimensional objects, the apparatus comprising:
a stream generating unit configured generate a gas stream, the gas stream streaming through a process chamber of the apparatus; and
a gas processing device comprising at least one gas determination unit configured determine a composition of the gas streaming through the process chamber of the apparatus;
wherein the gas processing device is configured to guide the gas stream to at least one gas purification device or to the process chamber based at least in part on the determined composition of the gas.

2. The apparatus of claim 1, wherein the gas processing device is configured to guide the gas stream to the process chamber based at least in part on a defined composition of the gas.

3. The apparatus of claim 2, wherein the gas processing device is configured to adjust the defined composition of the gas that is guided to the process chamber based at least in part on at least one build material parameter and/or at least one process parameter.

4. The apparatus of claim 3, wherein the gas processing device is configured to adjust the defined composition of the gas based at least in part on a type of build material used in an additive manufacturing process performed on the apparatus and/or based at least in part on at least one mechanical property of the object.

5. The apparatus of claim 1, wherein the at least one gas purification device comprises:
at least one moisture removing unit configured to remove water from the gas stream; and/or
at least one gas removing unit configured to remove a gaseous component from the gas stream.

6. The apparatus of claim 5, wherein the at least one moisture removing unit comprises two moisture removing elements; and/or
wherein the at least one gas removing unit comprises two gas removing elements.

7. The apparatus of claim 6, wherein the at least one moisture removing unit and the at least one gas removing unit are arranged in series; and
wherein the two moisture removing elements are arranged in parallel with respect to a streaming direction of the gas stream, and/or the two gas removing elements are arranged in parallel with respect to a streaming direction of the gas stream.

8. The apparatus of claim 7, wherein the at least one gas purification device is configured to guide the gas stream to one of the two moisture removing elements and/or to one of the two gas removing elements based at least in part on an operational status.

9. The apparatus of one of the claim 5, wherein the at least one moisture removing element and/or the at least one gas removing element comprise refreshable or renewable removing material and/or a removing structure.

10. The apparatus of one of the claim 5, wherein the gas processing device is configured to bypass at least a portion of the at least one gas purification device based at least in part on the determined composition of the gas.

11. The apparatus of claim 1, wherein the gas processing device comprises a gas supply unit configured provide at least one fresh gas to the process chamber and to adjust a volumetric flow rate of the fresh gas to the process chamber based at least in part on the determined composition of the gas.

12. The apparatus of claim 1, wherein the gas processing device comprises a cover gas supply unit configured to provide at least one cover gas and configured to adjust a volumetric flow rate of the at least one cover gas to the process chamber based at least in part on the determined composition of the gas.

13. The apparatus of claim 1, wherein the gas processing device comprises a valve arrangement configured to guide the gas stream to the process chamber or the at least one gas purification device, wherein:
the valve arrangement is configured to bypass at least one moisture removing unit and/or at least one gas removing unit;
the valve arrangement is configured to guide the gas stream selectively to one of at least two moisture removing elements; and/or
the valve arrangement is configured to guide the gas stream selectively to one of at least two gas removing elements.

14. A method of additively manufacturing three-dimensional objects, the method comprising:
generating a gas stream with a stream generating unit and streaming the gas stream through a process chamber of an apparatus for additively manufacturing three-dimensional objects;
determining, with a gas processing device comprising at least one gas determination unit, a composition of the gas streaming through the process chamber of the apparatus; and
guiding the gas stream, at least in part using the gas processing device, to at least one gas purification device or to the process chamber based at least in part on the determined composition of the gas.

15. The method of claim 14, comprising:
guiding the gas stream, at least in part using the gas processing device, to the process chamber based at least in part on a defined composition of the gas; and
adjusting the defined composition of the gas that is guided to the process chamber based at least in part on at least one build material parameter and/or at least one process parameter.

16. The method of claim 15, comprising:
adjusting the defined composition of the gas that is guided to the process chamber based at least in part on a type of build material used in an additive manufacturing process performed on the apparatus and/or based at least in part on at least one mechanical property of the object.

17. The method of claim 19, comprising:
bypassing, with the gas processing device, at least a portion of the at least one gas purification device based at least in part on the determined composition of the gas.

18. The method of claim 14, comprising:
providing, with the gas processing device, at least one fresh gas to the process chamber and adjusting a volumetric flow rate of the fresh gas to the process chamber based at least in part on the determined composition of the gas, the gas processing device comprising a gas supply unit configured provide the at least one fresh gas and to adjust the volumetric flow rate of the at least one fresh gas; and/or
providing, with the gas processing device, at least one cover gas to the process chamber and adjusting a volumetric flow rate of the at least one cover gas to the process chamber based at least in part on the determined composition of the gas, the gas processing device comprises a cover gas supply unit configured to provide the at least one cover gas and to adjust the volumetric flow rate of the at least one cover gas.

20. The method of claim 14, comprising:
guiding, with the gas processing device, the gas stream to the process chamber or to the at least one gas purification device, the gas processing device comprising a valve arrangement configured to guide the gas stream to the process chamber or the at least one gas purification device, wherein guiding the gas stream comprises:
bypassing, with the valve arrangement, at least one moisture removing unit and/or at least one gas removing unit;
selectively guiding, with the valve arrangement, the gas stream to one of at least two moisture removing elements; and/or
selectively guiding, with the valve arrangement, the gas stream to one of at least two gas removing elements.
